(19) United States
(12) Patent Application Publication
(10) Pub. No.: US 2012/0191516 A1
(43) Pub. Date: Jul. 26, 2012

(54) DISTRIBUTED APPARATUS AND SYSTEM FOR PROCESSING CLIENT REFERRALS AND REFERRAL FEES

(76) Inventor: Marsha Taicher, Luxemburg, WI (US)

(21) Appl. No.: 13/440,477

(22) Filed: Apr. 5, 2012

Related U.S. Application Data
(63) Continuation of application No. 12/431,100, filed on Apr. 28, 2009.

(51) Int. Cl. G06Q 30/02

(52) U.S. Cl. 705/14.16

(57) ABSTRACT

An apparatus configured with software to create a geographical distributed referral system, assign a monetary value to referrals and to efficiently process direct cash payments to the referral source without requiring that of the referral source have knowledge about a particular provider of goods and services which will fulfill the referral.

### CROSS-REFERENCE TO RELATED APPLICATIONS

This application is a continuation of U.S. patent application Ser. No. 12/431,100 filed Apr. 28, 2009, the content of which is incorporated herein by reference in its entirety.

### FIELD OF INVENTION

This invention relates to a system and apparatus for transforming referral data and generating cash payments directly to referral sources.

### BACKGROUND

There are many models available for networking groups and systems for making business referrals. For example, Chambers of Commerce are traditional networking groups which further the business interests of the community by generating referrals. Many have websites a prominent online presence and generate referrals among members. Generally, chamber members do not receive payments or compensation for referrals.

Business Network international, Inc., (“BNI”) with a website located at www.BNI.com claims to have generated $2.3 billion through 5.6 million business referrals in 2008. The website states that the “mission of BNI is to help members increase their business through a structured, positive, and professional “word-of-mouth” program that enables them to develop long-term, meaningful relationships with quality business professionals.

BNI derives revenues solely from membership fees, dues and from sales of its products (e.g., books) online. Local networking groups meet face-to-face periodically, and monitors the number and type of referral generated by and to each member using some software tools. However, referral data is not tracked, processed or transformed in a manner which allows referring members to receive monetary payments.

Angie's List, Inc. (“Angie's List”) is another business referral system with its website located at www.angieslist.com which relies upon membership fees as its revenue model. Vendors are added to the list only after a user files a “report” on them. Vendors do not pay to be on the referral list. Angie's List is a subscription based service, and membership dues are paid by users who wish to access the service provider lists and data. Service users who file a report are not “tracked” or monetarily compensated for the references or referrals and there is not transformation of data for this purpose.

Various pending and issued patents exist for referral systems and associated hardware and software technology. For example, U.S. Patent Application 2007/0,282,904 A1 (Mitchell '904), teaches online, network-based method and system for listing professional referrals for attorneys and allowing attorneys to bid on the referrals using credits they receive for subscribing to the referral service. Mitchell '904 also teaches a system by which revenue is primarily derived from memberships. Mitchell does not teach a system for compensating referral source providers or transforming data for the purpose of doing so.

Affiliate marketing is a type of internet-based marketing practice in which a business or individual pays a commission for each visitor or customer brought about by the affiliate's marketing efforts. Examples of websites which have affiliate marketing programs for referrals and pay commissions include www.amazon,com, www.reueters.com and horsesmouth.com. However, a problem known in the art with respect to this type of tracking and data transformation is that users must directly refer a potential customer to a particular vendor site, and the referral source must directly identify themselves.

The foregoing business models are merely exemplary of those known in the prior art. Typically referral-type services rely on revenue from service providers, or commissions for referrals, and thus are limited in their ability to attract referrals, track and match referral sources and new customers and to transform this data into a system for compensating referral sources.

It is desirable to have a system and software configured apparatus for creating financial incentives for purchasers of goods and services and for efficiently matching referral sources and customers and compensating those who generate valuable referrals.

It is further desirable to create a system and software configured apparatus that allows a person providing a referral to appropriately refer a purchaser of goods and services and profit from the referral without requiring the referral source to have any direct knowledge of a person or entity capable of fulfilling the purchaser's needs.

It is further desirable to create a system and software configured apparatus that allows a referral source to conveniently recommend a purchaser of goods and services and profit from a referral to a wide range of vendors without requiring the referral source to have specific product knowledge or to negotiate with a particular vendor for a commission arrangement.

### BRIEF DESCRIPTION OF THE DRAWINGS

FIG. 1 illustrates a server configured with software components for transforming referral request objects to referral fulfillment objects and issuing payments to the referral source.

FIG. 2 illustrates a distributed hardware apparatus configured with software for transforming referral request objects to referral fulfillment objects and issuing payments to the referral source.

FIG. 3 is a flowchart illustrating an exemplary method for transforming referral request objects to referral fulfillment objects and making a payment to a referral source which can be implemented within a hardware apparatus or system

FIG. 4 is a flowchart of a method for transforming referral request objects referral fulfillment objects which further includes a vendor rating software component and the capability for and displaying related rating information on a user interface.

### GLOSSARY

The following are terms used in connection with the apparatus and system for processing referral fees disclosed herein:

As used herein, “back-end revenue processing” means aspects of sales, referral fulfillment and revenue processing with which a customer or referral does not generally come in contact and/or know all details. Examples of back-end revenue processing include but are not limited to payment of commissions and referral fees, and other business functions, such as accounting, administration, communications data processing, document handling.

As used herein, the term “customer” means a person or entity willing to purchase goods and services for payment pursuant to identifiable criteria, which can be specified in a referral request or referral request object.

As used herein, the term “customer fulfillment data” means any data about whether a customer request or need was fulfilled, including but not limited to customer payment, referral source payment, system administrator payment, rating information, pricing, time frame or any other customer fulfillment information known in the art.

As used herein, the term “distributed hardware apparatus” means a computer apparatus having components distributed over several geographical locations and/or locations within buildings.

As used herein, the term “local hardware apparatus” means a local computer apparatus which is configured with software to transform referral request objects, referral fulfillment objects, payments, referral source objects and provider rating objects.

As used herein, the term “payment” means any cash, credit, scrip, any substitute for currency and/or item of actual or symbolic value used to compensate a referral source. A payment may be converted to cash or assigned a cash equivalent for payment of cash.

As used herein, the term “provider” or means a seller of goods and/or services which can fulfill a referral request.

As used herein, the term “provider object” or means data about a seller of goods and/or services which can be matched to or transform a referral request or referral request object.

As used herein, the term “data” or “vendor rating data” means any data associated customer satisfaction, reputation, performance, cost or perceived value of a provider's goods and services.

As used herein, the terms “receiving mechanism” or “means for receiving” generally refer to any computer, software, database, recording device, voice and data recognition device, interface or other device or software which is designed to receive, record or store at least one user selected criteria.

As used herein, the term “referral” means information or data which can be transformed into a referral request or referral request object.

As used herein the term “referral fulfillment” or “referral fulfillment object” means data or a data object which includes but is not limited to the following information: whether a service was performed, the person or entity that requested the service, the person or entity that performed the service, whether the service request was deemed fulfilled, the fee charged for the service and any other information relevant to goods and services provided to a customer.

As used herein the term “referral request” or “referral request object” means data and attributes related to a person or entity requesting a referral. For example, a referral request may include but not be limited to the following data: service requested, description of project, identification information of requester, history of prior referrals, geographical data, demographic data, socioeconomic data.

As used herein, the term “referral source” means a person or entity providing a referral.

As used herein, the term “referral source object” means data and attributes related to a person or entity requesting a referral. For example, a referral request may include but not be limited to the following data: service requested, description of project, identification information of requestor, history of prior referrals, geographical data, demographic data, socioeconomic data.

As used herein, the term “system administrator” means the owner and/or administrator of the Distributed Apparatus and System for Processing Client Referrals and Referral Fees disclosed herein, or the authorized payee for its use.

As used herein the term “user” generally refers to any person or entity that accesses, views or modified data maintained by the system and apparatus described herein.

As used herein, the term “transform” means to generate, update or modify.

As used herein, the term “user interface” physical media (e.g. paper or a computer screen) on which data described by the system and apparatus herein can be displayed. Computer, software, database, recording device, voice and data recognition device, interface or other device or software which is designed to display referral data, service provider data, fulfillment data, fee data or account data or any other data generated or transformed by the method and system disclosed herein.

As used herein the term “user” generally refers to any person or entity that accesses, views or modifies data maintained by the system and apparatus described herein.

As used herein the term “voice and data recognition enabled device” is a device which allows input of data by means of the human voice.

### DETAILED DESCRIPTION OF DRAWINGS

For the purpose of promoting an understanding of the present invention, references are made in the text to exemplary embodiments of a Distributed Apparatus and System for Processing Client Referrals and Fees, only some of which are described herein. It should be understood that no limitations on the scope of the invention are intended by describing these exemplary embodiments.

One of ordinary skill in the art will readily appreciate that alternate but functionally equivalent software and hardware components, software objects and steps may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale, instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

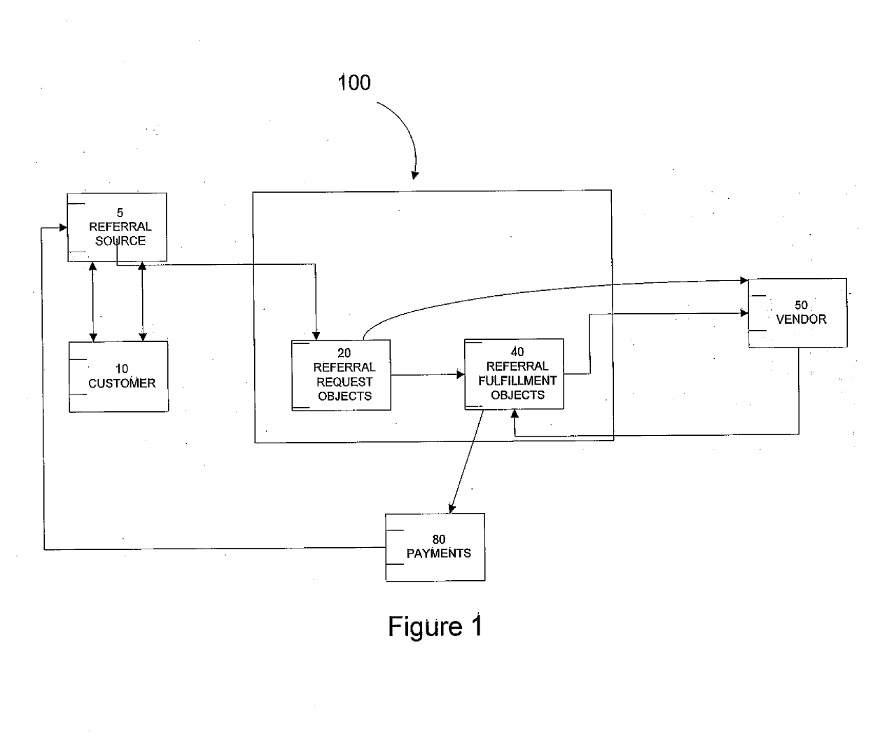

FIG. 1 is an exemplary Distributed Apparatus and System for Processing Client Referrals and Referral Fees which resides on server 100 configured with software for transforming data from referral source 5 pertaining to customer 10 to a referral request objects 20 and then to referral fulfillment object 40 which is communicated to vendor 50. Data from vendor 50 is used to modify and update data within the referral fulfillment object 40 and to calculate and issue payment(s) 80 to the referral source 5.

In the embodiment shown, referral source 5 becomes aware that customer 10 is in need of goods and services (e.g., copiers, legal services, printing, cleaning, industrial equipment, landscaping or any other good or service which can be purchased with cash, credit or a check. Referral source 5 need not know of a specific vendor or have any information about products, services or pricing.

Referral source 5 may connect to server 100 and provides data about customer 10 which is used by server 100 to transform referral request object 20 and/or referral fulfillment object 40 provided by a vendor. Data from referral request object 20 is transmitted to one or multiple vendor(s) 50 who may respond to provide goods and services on any pricing basis specified in referral fulfillment object 50. Various embodiments of the system may embody pricing policies to verify that customer 10 is receiving a price normally charged by vendor 50 without markup to reflect the fee charged to the vendor for access to server 100.

Vendor 50 is required to report performance and fulfillment data which is used to update referral fulfillment object 40 and the bill the vendor. Referral fulfillment object 40 is update to reflect payment to a system administrator for use of the system and server 100 services. Data from referral fulfillment object 40 (when referral requests are fulfilled) are used to generate payment 80 to referral source 5.

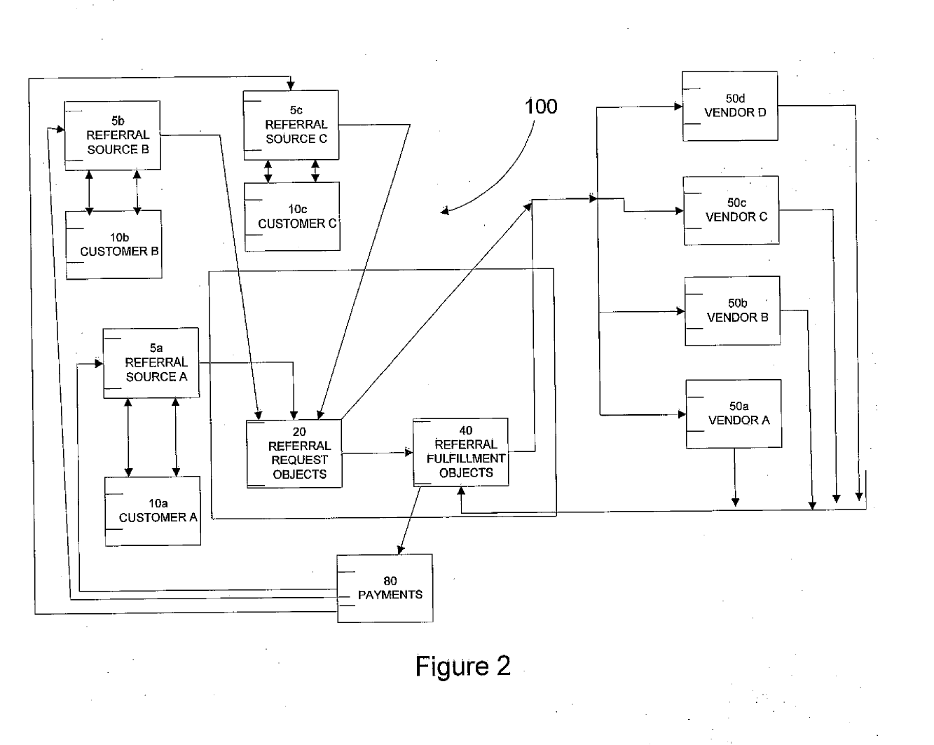

FIG. 2 illustrates a distributed hardware apparatus 100 configured with software for transforming referral request data or request data objects to referral data or referral fulfillment objects and issuing payments to a referral source.

In the embodiment shown, multiple hardware components are configured with software for transforming data from geographically disparate referral sources 5 pertaining to multiple customers within customer database(s) 10 to generate referral request objects 20 and referral fulfillment object(s) 40 for vendors contained within vendor databases 50. Data from vendor databases 50 is used to modify and update data within the referral fulfillment object 40 and to calculate and issue payment(s) 80 to the referral source (s) 5.

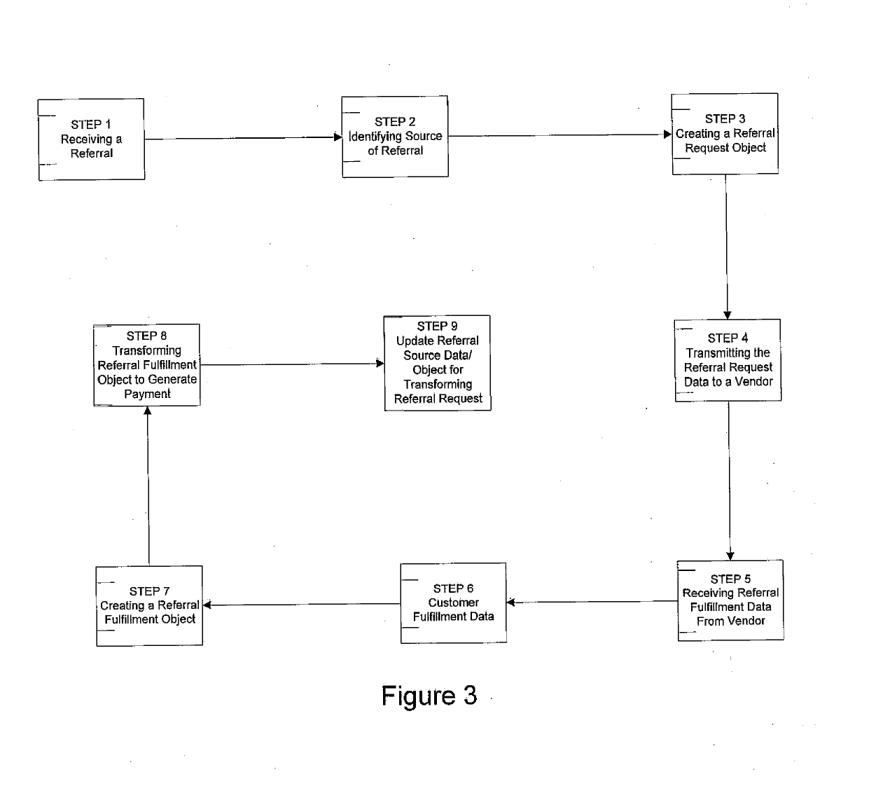

FIG. 3 is a flowchart of one exemplary embodiment of method used to configure an apparatus for Processing Client Referrals and Referral Fees.

Step 1 includes receiving a referral from a referral source of a customer which has a need for goods and services.

Step 2 includes identifying a referral source and storing data pertaining to the referral source. A referral source may be any person or entity with knowledge of a customer need for goods and services which provides data which can be transformed to a data referral request object.

Step 3 includes the step of creating a referral request object which includes data and attributes related to a person or entity requesting a referral. For example, a referral request object or may include but not be limited to the following data: service requested, description of project, identification information of requestor, history of prior referrals, geographical data, demographic data, socioeconomic data.

Step 4 includes the step of transmitting the referral request data to one or more vendors which has been investigated by a system administrator and/or rated by prior customers. In various embodiments of the method disclosed herein a vendor may have set pricing or rates, or customers may negotiate pricing independently with one or more vendors.

Step 5 includes the step of receiving fulfillment data from a vendor (including payment for use of the system) as to the vendor performance of services for a customer.

Steps 6 included the step of receiving customer fulfillment data from a customer which verifies the price paid by the customer and data concerning the customer's level of satisfaction

Step 7 includes the step of transforming (creating and updating) a referral fulfillment object to reflect vendor and customer provided data.

Step 8 includes the step of transforming data contained referral fulfillment object to generating a payment to a referral source.

Step 9 update referral source data/object for transforming referral request and indicating one or more referrals have been made and/or one or more payments have been remitted to a referral source.

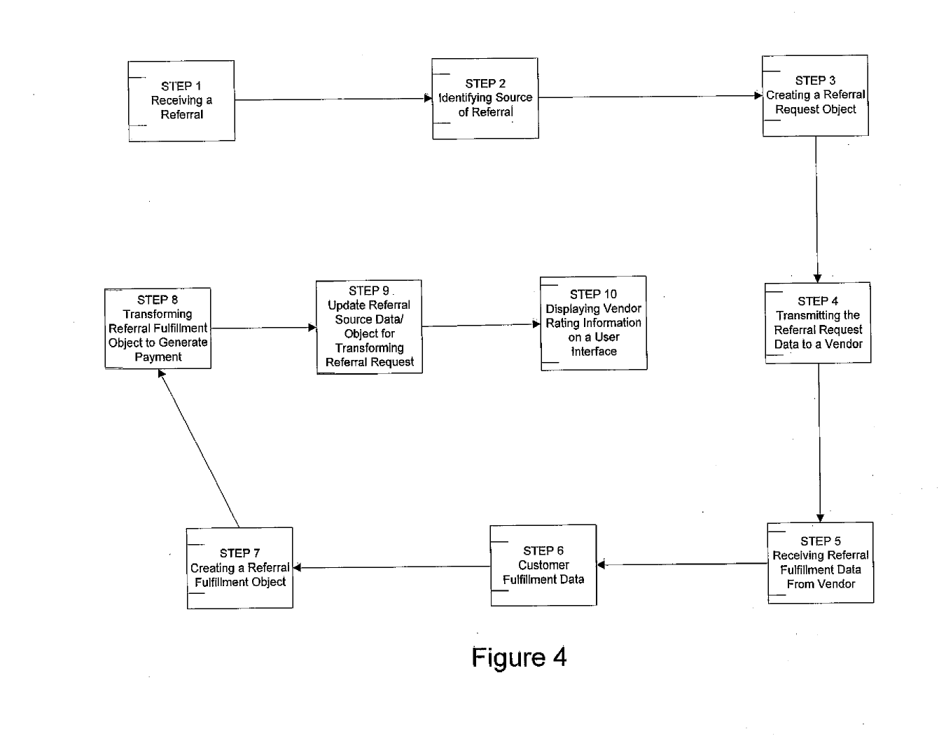

FIG. 4 is a flowchart of the method illustrated in FIG. 3 which further includes Steps 6 for receiving rating data from a customer as well as other types of fulfillment data so that the system administrator can monitor vendor performance.

FIG. 4 also includes Step 10 for displaying vendor rating information on a user interface so customers can view such ratings and consider them in selecting a vendor.

1. An apparatus configured with software for processing referral data to generate payments to a referral source:
at least one server;
said at least one server including at least one software component for receiving and transforming at least one customer data object;
said at least one server including at least one software component for receiving and transforming at least referral source object;
at least one software component capable of matching said at least one referral source with at least one customer;
a vendor database which includes at least one vendor data object;
at least one software component capable of matching said at least one customer source with at least one vendor and transforming said at least one vendor data object;
at least one order fulfillment data object; and
at least one software component for generating referral source payments capable transforming fulfillment data and referral source data to generate a payment.

2. The apparatus of claim 1 which is a distributed computer apparatus which is comprised of multiple servers configured with software for processing referral data to generate payments to a referral source.

3. The apparatus of claim 1 which further includes at least one vendor rating data software component.

4. The apparatus of claim 3 which further includes a user interface for displaying vendor rating data.

5. The apparatus of claim 1 which further includes at least one customer database.

6. The apparatus of claim 1 which further includes at least one vender database.

7. The apparatus of claim 1 which includes a software component for matching at least one customer from a customer database to at least one vendor database and transforming an order fulfillment data object.

8. The apparatus of claim 1 which further includes a referral source tracking software component for tracking data about at least one referral source.

9. The apparatus of claim 1 which further includes a system administrator payment processing software component which allows customers payments to be allocated to at least one system administrator and at least one vendor.

10. The apparatus of claim 1 which further includes a system administrator payment processing software processing software component which allows a system administrator to perform a task selected from a group consisting of transforming a software component, determining the method of allocating payments and transforming at least one data object.

11. The apparatus of claim 1 which further includes a system administrator payment processing software component which allows a system administrator to allocate payments received from a customer to a group consisting of at least one referral source, at least one vendor and at least one system administrator.

12. A method of processing referral data to generate payments to a referral source comprising the steps of:
receiving and transforming at least one customer data object;
receiving and transforming at least referral source object;
matching said at least one referral source with at least one customer;
matching said at least one customer with at least one vendor and transforming said at least one vendor data object;
Transforming at least one order fulfillment data object; and
generating referral source payments capable transforming fulfillment data and referral source data to generate a payment to said referral source.

13. The method of claim 12 which further includes the step of receiving vendor rating information and transforming at least one vendor data object.

14. The method of claim 13 which further includes the step of displaying vendor rating data on a user interface.

15. The method of claim 12 which further includes the step of allocating payments received from a customer to a group consisting of at least one referral source, at least one vendor and at least one system administrator.

16. A system configured with software for back-end processing of referrals and referral payments comprised of:
at said at least one server including at least one software component for receiving and transforming at least one customer data object;
at said at least one server including at least one software component for receiving and transforming at least referral source object;
at least one software component capable of matching said at least one referral source with at least one customer;
a vendor database which includes at least one vendor data object;
at least one software component capable of matching said at least one customer source with at least one vendor and transforming said at least one vendor data object;
at least one user interface;
at least one vendor rating software component;
at least one order fulfillment data object; and
at least one software component for generating referral source payments capable of transforming fulfillment data and referral source data to generate a payment.

17. The system of claim 16 which further includes a system administrator payment processing software component which allows customers payments to be allocated to at least one system administrator and at least one vendor.

18. The system of claim 16 which further includes a system administrator payment processing software processing software component which allows a system administrator to perform a task selected from a group consisting of transforming a software component, determining the method of allocating payments and transforming at least one data object.

19. The system of claim 16 which includes multiple servers configured with software.

20. The system of claim 16 which is adapted to be administered by more than one system administrator.
